(19) United States
(12) Patent Application Publication
(10) Pub. No.: US 2017/0149522 A1
(43) Pub. Date: May 25, 2017

(54) METHOD AND SYSTEM FOR ACOUSTIC COMMUNICATION

(71) Applicant: THALES, COURBEVOIE (FR)

(72) Inventor: Jean-Michel PASSERIEUX, Sophia-Antipolis (FR)

(73) Assignee: THALES, Courbevoie (FR)

(21) Appl. No.: 15/319,703

(22) PCT Filed: Jun. 19, 2015
(86) PCT No.: PCT/EP2015/063861

§ 371 Date: Dec. 16, 2016

(30) Foreign Application Priority Data
Jun. 20, 2014 (FR) 1401400

(51) Int. Cl. H04K 1/02; H04K 1/00; H04B 11/00

(52) U.S. Cl. CPC H04K 1/02; H04B 11/00; H04K 1/006; H04K 2203/12

(57) ABSTRACT

A transmitter device comprises a transmission antenna with at least one transducer and one signal generation unit for generating an acoustic communication signal to be transmitted to a receiver device including hidden information, wherein the signal generation unit is configured to previously record an original acoustic signal, the signal generation unit capable of generating the communication signal to be transmitted by adding, to an initial signal x(t) derived from the original signal, an auxiliary signal previously multiplied by at least one symbol, the symbol having a phase and/or an amplitude carrying the hidden information and the auxiliary signal calculated from the initial signal by a chosen transformation operator which depends on a steganographic key.

### CROSS-REFERENCE TO RELATED APPLICATIONS

This application is a National Stage of International patent application PCT/EP2015/063861, filed on Jun. 19, 2015, which claims priority to foreign French patent application No. FR 1401400, filed on Jun. 20, 2014, the disclosures of which are incorporated by reference in their entirety.

### FIELD OF THE INVENTION

The invention generally relates to acoustic communications, and, in particular, to a method and a system for discreet submarine acoustic communications.

### BACKGROUND

Discreet submarine acoustic communication systems transmit acoustic communication signals (audio streams) to target receivers such that these signals are not detected by third parties or, if they are detected by third parties, are considered thereby to be an unremarkable component of ambient noise.

Multiple solutions have been proposed in the past for hiding the information in an audio stream, for example in order to hide short messages of SMS (short message service) type therein. The hidden information may then be accessed only by the target receivers, which are equipped with specific decoding boxes.

More recently, music editors or broadcasters have developed multiple solutions making it possible to hide, within audio files of .wav or .mp3 type, copyright information or specific marks intended to be used as evidence in the event of pirating or non-authorized broadcast of the content of these files. These solutions are, for example, based on encoding techniques such as least significant bit encoding, the addition of narrowband weak auxiliary signals or of echoes. Their application is mainly limited to transmission via low-noise channels, without Doppler shift or multipaths, and, above all, solely to digital channels as described in the following articles:
N. Cvejic “Algorithms for audio watermarking and steganography”, Academic dissertation, University of Oulu, 2004,
R. Walker, “Audio Watermarking”, BBC R&D White Paper, WHP 057, August 2004,
K. Gopalan, “Audio steganography using bit modification”, Proc. IEEE International Conference on Acoustics, Speech, and Signal Processing, (ICASSP '03), Vol. 2, pp. 421-424, April 2003,
Gopalan, “Audio Steganography for Covert Data Transmission by Imperceptible Tone Insertion”, Proc. the IASTED International Conference on Communication Systems And Applications (CSA 2004), Banff, Canada, July 8-10, 2004.

Discreet acoustic communication systems may be based on digital communications. In a first approach, the system transmits a signal carrying the information at a very low level so as not to be detected by a third party. The communication signal then has a signal-to-noise ratio that is too low for detection by a third party. All solutions of this type are characterized by a relatively low information bit rate (low spectral efficiency, typically of the order of a few 10⁻¹ bit/sec/Hz).

Multiple solutions have been proposed according to this first approach, such as, for example, solutions based on spread spectrum techniques, such as, for example, in J. G. Proakis, “Digital Communications”, Mc Graw Hill, 4^{th} edition, 2001. Knowledge of the used spreading code or sequence used, along with adequate processing, then allows the transmitted signal to be detected by the recipient of the message only. The recipient of the message may then extract the information therefrom. However, such solutions allow only a low bit rate to be reached. Furthermore, a third party other than the target recipient could detect the communication signal and identify the spreading sequence by analyzing signals received over a long duration (G. Burel, Detection of Spread Spectrum Transmission Using Fluctuations of Correlation Estimators, IEEE-ISPACS, Honolulu, November 2000).

A technique derived from the preceding solutions and based on the use of OFDM modulations is also known (G. Leus and P. van Walree “Multiband OFDM for covert acoustic communications”, IEEE Journal on Selected Areas in Communications, Vol. 26, N° 9, December 2008). It is possible that this technique theoretically allows the cyclostationary properties of OFDM signals to be exploited in order to detect them and identify them as information carriers. However, this detection requires complex algorithms and the availability of long signals.

There also exists a solution based on the first approach which, instead of using one and the same pseudo-random sequence looping throughout the transmission as the spreading sequence, uses a chaotic sequence, i.e. white noise generated by a chaotic oscillator or a non-periodic random signal (Stéphane PENAUD, Philippe BOUYSSE, Jacques GUITTARD et al, Potentialités des séquences d'étalement chaotiques pour I'amélioration du TEEB d'un systéme DS-CDMA asynchrone (Potential of chaotic spread sequences for improving the TEEB of an asynchronous DS-CDMA system), ANN. TELECOMMUN., 58, n ° 3-4. 2003).

This absence of periodicity makes it impossible to detect the communication signal using the preceding techniques. Nevertheless, problems of transmitter/receiver synchronization are posed which make it impossible to apply it to a simple and inexpensive communication system (due, in particular, to the need for frequent and indiscreet resynchronizations, or the need to use extremely precise clocks which are expensive and difficult to integrate within a “small” acoustic communication system).

Other solutions have been proposed, in a second approach. These solutions consist of transmitting signals of unremarkable appearance, for example signals that may be mistaken for signals from marine mammals, submarine construction of unremarkable buildings, sounds of the sea (waves, wind, rain, etc.) without restrictions regarding the transmitted level as long as it is kept to a permissible level and is weak enough that the transmitted signal indeed appears to be natural. For example, one technique of this type consists of transmitting broadband sequences of clicks resembling the clicks of dolphins, the spacing between the clicks carrying the information to be transmitted (H. S. Dols et al, “Covert underwater acoustic communication with marine mammal sounds”, Proc. UDT Europe 2008). However, with such techniques, it is difficult to generate signals that do not have a synthetic feel (true vocalizations or clicks of marine mammals). They additionally require the transmission of signals that are compatible with the place and time of transmission (for example, signals resembling a species unknown in the area of the transmitter should not be transmitted, the cracking of icebergs should not be simulated in the Mediterranean, etc.).

### SUMMARY OF THE INVENTION

The invention improves the situation. To this end, it proposes a transmitter device, comprising a transmission antenna, the transmission antenna comprising at least one transducer and one signal generation unit for generating an acoustic communication signal to be transmitted to a receiver device including hidden information. Advantageously, the signal generation unit is configured to previously record an original acoustic signal and generate the communication signal to be transmitted by adding, to an initial signal x(t) derived from the original signal, an auxiliary signal previously multiplied by at least one symbol, the symbol having a phase and/or an amplitude carrying the hidden information and the auxiliary signal being calculated from the initial signal by means of a chosen transformation operator which depends on a steganographic key.

According to one feature of the invention, the initial signal derived from the original signal is the complex baseband signal obtained after filtering the original signal in a frequency band of chosen width, centered on a central frequency.

According to another feature, the signal generation unit is configured to previously divide the total duration of the original signal x(t) into a set of contiguous successive time intervals of the same duration T, the transformation operator being applied to the initial signal on each of these intervals in order to calculate the value of the corresponding auxiliary signal on the interval.

In particular the communication signal generated y(t) at a time t belonging to the n^{th} interval [nT, (n+1)T] is equal to:

y(t)=x(t)+α.aₙ.Ψ(x)(t),
where a denotes a gain parameter and aₙ denotes the symbol corresponding to the n^{th} interval.

In a first embodiment, the signal generation unit is additionally configured to divide the total duration of the initial signal into a set of contiguous successive time intervals of the same duration T, and each interval of duration T into 2M sub-intervals U. M, . . . , U₋₁, U₁, . . . , U_{M}, separated by guard intervals, the durations of the sub-intervals increasing as a function of the absolute value of k, the transformation operator being applied to the initial signal over each sub-interval Uₖ in order to calculate the corresponding value of the auxiliary signal on the interval.

In this embodiment, the value of the auxiliary signal Ψ(x)(T/2+t) at a time T/2+t, where t belongs to a sub-interval Uₖ, may be a function of a phase parameter exp j.βₖ, with βₖ being comprised in the interval [0, 2π] and k is being comprised in the interval [−M, M], of the value of an amplitude weighting function p(t) at time t, and of the value of the initial signal at time (T/2−t).

In particular, the value of the auxiliary signal Ψ(x)(T/2+t) at a time T/2+t, where t belongs to a sub-interval Uₖ, may be equal to:

Ψ(x)(T/2+t)=expj.βₖ.p(t).x(T/2−t).

The duration of the guard intervals between the sub-intervals of successive times Uₖ and Uₖ₊₁ may be chosen such that each of the sub-intervals Uₖ does not overlap with its neighbors after dilation/compression due to a Doppler phenomenon.

In a second embodiment, the signal generation unit may additionally be configured to divide each interval of duration T into a set of M sub-intervals of the same duration T/M, the value of the auxiliary signal in a given sub-interval of time being obtained from the value of the initial signal in another sub-interval.

In particular, in this embodiment, the value of the auxiliary signal at a time t belonging to a given sub-interval of time may be obtained from the value of the initial signal at time −t in another sub-interval (time reversal).

In addition, the value of the auxiliary signal at a time t belonging to a given sub-interval of time may be obtained from the value of the initial signal in another sub-interval weighted by the value of an amplitude weighting function p(t) at time t.

The invention additionally proposes a receiver device comprising a receiving antenna, the receiving antenna comprising at least one hydrophone. The receiver device also comprises a detector for detecting a communication signal transmitted by a transmitter device according to one of the preceding features and an extraction unit configured to reconstruct the auxiliary signal by applying said transformation operator to the detected communication signal from the steganographic key, and to extract the hidden information from the phase and/or the amplitude of the reconstructed auxiliary signal.

The extraction unit may additionally be configured to apply a filter to the reconstructed signal from a compensation term [symbol] capable of compensating for the residual of the carrier corresponding to the difference between the carrier frequency with Doppler and the nominal carrier frequency, the compensation term being estimated by maximizing, at each time t, the modulus of the output z(t) of the filter for a set of possible values of θ. The extraction function is then capable of determining the symbols and the bits of the hidden information from the phases of the signal z(t) that are calculated at times corresponding to the maxima of the modulus of the signal z(t).

The invention further proposes a communication system comprising a transmitter device and a receiver device according to one of the preceding features.

The invention also proposes a transmission method for generating an acoustic communication signal in a transmitter device (101), comprising a transmitting antenna, the transmitting antenna comprising at least one transducer, the method comprising the following steps:

a. recording an original acoustic signal;

b. adding, to an initial signal x(t) derived from the original signal, an auxiliary signal multiplied by at least one symbol, the symbol having a phase and/or an amplitude carrying the hidden information and the auxiliary signal being calculated from the initial signal by means of a chosen transformation operator which depends on a steganographic key, thereby providing a communication signal;

c. transmitting a signal to a receiver device from the communication signal obtained in step b.

The transmitted signal may thus appear perfectly natural to a third party, in contrast to an overly regular synthetic signal. It is additionally still well adapted to the time and place of transmission.

This solution is applicable to all signal types, with variable levels of performance in terms of possible bit rates. It is particularly suitable for a very noisy environment.

### DESCRIPTION OF THE FIGURES

Other features and advantages of the invention will become apparent with the aid of the description which follows and the figures of the appended drawings in which:

FIG. 1 is a diagram representing the acoustic communication system according to certain embodiments of the invention;

FIG. 2 is a flowchart representing the transmission method according to certain embodiments of the invention;

FIG. 3 is a schematic representation illustrating the division of the interval T into 2M sub-intervals;

FIG. 4 is a diagram illustrating the construction of the auxiliary signal by means of the transformation operator according to the first embodiment;

FIGS. 5 and 6 are diagrams representing an initial signal and the corresponding modified signal with the insertion of 16 bits, respectively, according to one exemplary embodiment;

FIGS. 7 and 8 are diagrams representing an initial signal and the corresponding modified signal with the insertion of 50 bits, respectively, according to one exemplary embodiment;

FIG. 9 is a flowchart representing the reception method, according to certain embodiments of the invention;

FIGS. 10 and 11 are diagrams representing the impulse response in an acoustic channel as a function of time and the power delay profile as a function of delay, obtained for a signal in a simulated submarine acoustic channel;

FIGS. 12 and 13 represent exemplary outputs obtained using the reception method, for two different exemplary initial signals;

FIG. 14 represents the symbols detected for the example of FIG. 12;

FIG. 15 represents the symbols detected for the example of FIG. 13;

FIG. 16 is a diagram illustrating the construction of the auxiliary signal by means of the transformation operator according to the second embodiment;

FIG. 17 represents a spectrogram of the original audio signal for an exemplary recording of clicks;

FIG. 18 represents the modified audio signal carrying 8 bits of information corresponding to the original audio signal of FIG. 17; and

FIG. 19 represents the output of the receiver, in the exemplary signal of FIG. 14, as a function of the correlation time for correlating the received signal with the auxiliary signal carrying the information.

The drawings will be able not only to aid in better understanding the description, but also to contribute to the definition of the invention, as appropriate.

### DETAILED DESCRIPTION

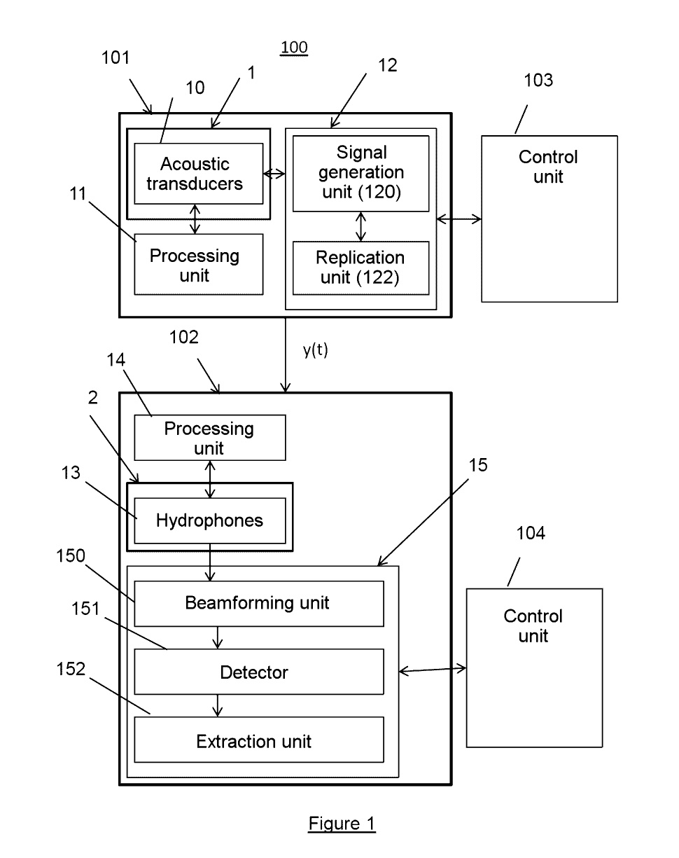

FIG. 1 represents a discreet digital submarine communication system 100, according to certain embodiments of the invention, configured to transmit a signal comprising the hidden information between a transmitter and a target receiver.

The communication system 100 comprises a transmitter device 101, provided at the transmitter, for transmitting a communication signal to a receiver device 102, provided at the receiver, for receiving the transmitted signal.

The transmitter device 101 is configured to transmit an original acoustic signal, previously recorded and modified so as to carry the hidden information by adding, to an initial signal x(t) derived from the original signal, a signal q(t) which is dependent on:

an auxiliary signal, denoted by Ψ(x)(t), calculated from the initial signal x(t) by means of a transformation operator Ψ (for example chosen by the transmitter); and

a symbol aₙ comprising an amplitude and/or a phase carrying the hidden information.

The original acoustic signal, as used here, refers to an acoustic signal arising from a natural source. Throughout the rest of the description, the original acoustic signal will also be referred to by the expression “original signal”. The original acoustic signal may be a chunk of ambient noise of unremarkable appearance. This chunk of unremarkable ambient noise may, for example, be a noise from a marine mammal present in the area, a noise from rain or waves, or else the noise radiated by an inoffensive trawler, etc.

The signals x(t), q(t) and Ψ(x)(t) vary as a function of time t.

The amplitude of the added signal q(t) corresponds to the amplitude of the symbol and may, in particular, be low with respect to the amplitude of the initial signal so as to remain imperceptible to third parties.

The receiver device 102 is capable of reconstructing the auxiliary signal in an approximative manner, by applying the same transformation operator Ψ to the received signal, detecting the auxiliary signal by means of a suitable filter and by extracting the information from the phase and/or the amplitude of the symbol.

More specifically, the transmitter device 101 comprises a transmitting antenna 1 comprising an acoustic transducer or a plurality of acoustic transducers 10 if the transmission is directional. Directional transmission makes it possible to improve the level of discretion in the event that the transmitter knows, even in an approximative manner, where the receiver is located.

The transmitter device 101 may additionally comprise processing units 11 associated with each transducer 10 such as, for example, digital/analog converters, power amplifiers or tuning/matching circuits associated with each of the transducers. Some of these processing units may be directly included within the transmitting antenna.

The transmitter device 101 may additionally comprise a computer 12 equipped with a signal generation unit 120 configured to generate an audio signal to be transmitted that corresponds to the initial signal modified with the hidden data. The computer 12 may additionally comprise replication units 122 configured to generate replicas of the signal to be transmitted by each of the transmission transducers (beamforming). Beamforming on transmission may allow the level of discretion to be substantially improved. Specifically, beamforming may be used to preferentially transmit in an angular sector comprising the receiver, thereby decreasing the possibility of interception by a third party located outside this sector (within the limitations due to transmission side lobes).

Specifically, the signal generation unit 120 may be configured to divide a signal recorded in successive and contiguous time blocks of fixed length T. In each block, the signal generation unit 120 may then calculate, from the initial signal x(t) and for t belonging to [0, T], an auxiliary signal denoted by Ψ(x)(t) (t belonging to [0, T]) by means of the transformation operator Ψ. This auxiliary signal is multiplied by a symbol aₙ which comprises a phase and/or an amplitude that depends on the information to be transmitted (hidden information). It may also be multiplied by a gain α chosen in order to attenuate it, in certain embodiments (the resulting signal q(t) is then equal to q(t)=α. aₙ.Ψ(x)(t)). The resulting signal q(t) may then be added to the initial signal x(t).

The receiver device 102 comprises a receiving antenna 2 comprising one or more hydrophones 13, each hydrophone being associated with processing units 14 such as preamplifiers and analog-digital converters. Some of these processing units 14 may be directly included within the transmitting antenna.

The receiver device 102 may additionally comprise a computer 15 comprising a beamforming unit 150 for forming beams in the one or more directions in which the transmitter is liable to be located (for example across the entire horizon in the absence of a priori information on the position of the transmitter, a single beam potentially covering the entire horizon if the receiver system is equipped with a single receiving hydrophone). The computer 15 may additionally comprise a detector 151 for detecting the presence of the information hidden in the signals on output from beamforming and an extraction unit 152 for extracting the information hidden in the signal detected by the detector 151.

The extraction unit 152 may be configured to generate, from the received signal y(t) and over a sliding window of length T, an approximate version of the auxiliary signal by applying the same transformation operator, namely {Ψ(y)(t), t=0, T}. It should be noted that the approximation of the auxiliary signal (also referred to as the “reconstructed auxiliary signal”) may become more precise the more the auxiliary signal has been attenuated by the gain α before being added to the transmission. The extraction unit 152 may subsequently calculate the scalar product between the received signal y(t) and the reconstructed auxiliary signal, then determine its phase, thereby providing the transmitted binary information (hidden information) in the form, for example, of one bit if BPSK modulation has been employed on transmission, or two bits in the case of QPSK modulation.

In an ideal transmission channel (one that is stationary and without multipaths), the signal resulting from the scalar product over the sliding window of duration T has peaks separated by a time interval T. The form of such peaks and their sharpness may depend on the autocorrelation function of the auxiliary signal. In an real channel, peaks have been observed whose form corresponds to the convolution product of the autocorrelation function of the impulse response h(t) of the acoustic channel (namely Cₕ(ζ)=∫h(ζ−t) h(t) dt) and and of that of the auxiliary signal.

In certain embodiments, the signal generation unit 120 may operate within a limited frequency band, which may be chosen depending on the characteristics of the initial signal x(t). Furthermore, the signal derived from the initial signal on the basis of which the auxiliary signal Ψ(x)(t) is determined may be the complex signal obtained after demodulating the initial signal around a central frequency or nominal carrier and in a given frequency band B. Once the signal q(t) has been added to the initial signal (thereby providing a signal y(t)), the signal to be transmitted may then be obtained by modulating the signal y(t) with the nominal carrier then by taking the real part of the signal thus modulated. In such an embodiment, on reception and before extracting the information, the extraction unit 152 demodulates the received signal around the nominal carrier frequency and in the frequency band B.

The communication system 100 may additionally comprise a control unit 103 associated with the computer 12 and a control unit 104 associated with the computer 15. Each control unit 103 and 104 may comprise human-machine interfaces (HMIs) and input and/or output peripheral devices, such as, for example, a screen and/or a keyboard, in order to allow the input or display of messages or information to be transmitted or received. In a variant, a single shared control unit, coupled both to the transmitter device 101 and to the receiver device 102, may be used. The control units (103, 104) may also allow the transmitter and receiver devices 101 and 102 to be controlled and configured.

The communication system 100 thus forms a discreet acoustic system allowing hidden information to be included within the transmitted signal, such as, for example, short tactical messages of a few tens of bytes (SMS, mail, predefined trigrams, etc.).

The information may be hidden in the amplitude of the symbol aₙ and/or in its phase when the quantity of information is more substantial.

Thus, the communication system 100 is capable of transmitting acoustic transmissions which, if they are intercepted by non-targeted receivers, do not allow the transmitter to be detected.

For example, the transmitter may be a submarine equipped with the transmitter device 101 for transmitting communication signals to receivers of type “friendly” buildings without these transmissions allowing the submarine to be detected by a hostile third party. The communication signals may be transmitted by active sonar on board the submarine and include any type of information.

The communication system 100 is nonetheless not limited to use in a submarine and may be used in various types of applications, such as, for example, in IFF (identification friend or foe) systems, in systems for wireless communications with robotic autonomous underwater vehicles (AUVs), on gliders, on divers or else on objects equipped with sensors placed on the seabed.

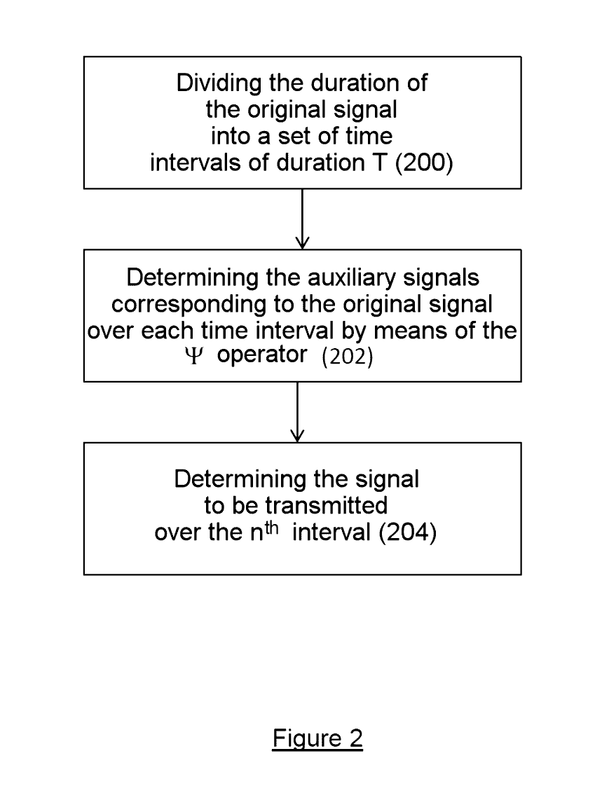

FIG. 2 is a flowchart describing the method of transmitting an audio signal by the transmitter, according to certain embodiments of the invention.

The original signal corresponds to an unremarkable element of ambient noise previously recorded.

In the first step 200 of the transmission method, the total duration of an initial signal x(t), derived from the original signal via an elementary operation (for example bandpass filtering), is divided into a set of non-overlapping contiguous successive intervals of the same duration T, for example of the order of a few hundreds of ms.

In step 202, the transformation operator Ψ is applied to the initial signal in each of these intervals. The transformation operator Ψ calculates, from the initial signal x(t), an auxiliary signal of the same duration T and of substantially (at least approximately) identical energy, in the same frequency band.

In step 204, the signal to be transmitted in the n^{th} interval [nT, (n+1)T], denoted by y(t), is determined as a function of the initial signal x(t), of the auxiliary signal Ψ(x)(t) and of the symbol aₙ. In particular, the signal y(t) may be obtained by adding the signal q(t) to the initial signal, this signal q(t) being dependent on the product between the auxiliary signal Ψ(x)(t) and the symbol aₙ. In one embodiment, the signal to be transmitted in the n^{th} interval [nT, (n+1)T], denoted by y(t), is equal to:

y(t)=x(t)+α.aₙ.Ψ(x)(t) (equation 1)

In equation 1:

α .aₙ. Ψ(x) (t) corresponds to the added signal q(t);

aₙ denotes an information symbol transmitted over the interval (for example aₙ=±1) if a binary modulation with two phase states BPSK is used; and

α denotes a gain <1, chosen to be low enough that the signal y(t) is close to the initial signal x(t).

The initial signal x(t) derived from the original signal may correspond to the complex baseband signal obtained after filtering the original signal x(t) in a frequency band of width B centered on a carrier or central frequency Fc. The use of such a derived signal allows other types of modulations with more than two phase states, with better spectral efficiency than BPSK modulation, to be used, for example QPSK, QAM16 and QAM64 modulations, thereby increasing the attainable bit rate.

According to another characteristic, the symbols aₙ may be based on differential encoding (DPSK), which has advantages in terms of robustness in a difficult environment. In a variant, it is also possible to transmit one or more known symbols in order to be able to identify and compensate for the phase of the acoustic channel (phase tracking and equalization).

In a variant, the initial signal x(t) derived from the original signal may correspond to the actual original signal. In this case, equation 1 may be applied by adding the amplitude of the initial signal x(t) to the relative amplitude of the auxiliary signal previously multiplied by the modulus of the symbols aₙ carrying the hidden information and, if applicable, by the gain α. Using the amplitude makes it possible to substantially increase the bit rates by using constellations of QAM type, for example QAM16 or QAM 64, with four or six bits per symbol.

In order to decrease the bit error rate, channel coding methods may be applied, such as, for example, an error-correcting code technique like the Reed-Solomon code or convolutional codes, with interleaving and/or scrambling of the bits to be transmitted through application of a xor with a long and known pseudo-random sequence in order to limit problems linked to the transmission of long sequences of 0s or 1s.

In a first embodiment of the division and association steps 200 and 204, each time interval of duration T may again be divided into 2M sub-intervals, denoted by U_{-M}, . . . , U₁, . . . , U_{M}, separated by short guard intervals (for example of the order of 1/10 of the duration of the intervals Uₖ) with durations increasing by |k|, as illustrated in the diagram of FIG. 3.

In step 202, the operator W is then chosen such that the value of the auxiliary signal W(x) (t) over each sub-interval Uₖ (for t ∈ to Uₖ) is dependent on:

the value of the initial signal x(t) over the sub-interval U₋ₖ (and vice versa), after time reversal (by replacing t by −t);

a phase exp j.βₖ; and

an amplitude weighting function p(t).

In particular, the value of the auxiliary signal Ψ(x)( ) at a time (T/2+t), for t belonging to a sub-interval Uₖ (for t ∈ to Uₖ), may be dependent on the product between the value of the initial signal x( )at time (T/2−t), on the phase exp j.βₖ and on the value of the amplitude weighting function p( ) at time t. In one embodiment, the auxiliary signal is obtained according to equation 2 below:

Ψ(x)(T/2+t)=expj.βₖ.p(t).x(T/2−t), if t ∈ Uₖ (equation 2).

The signal x(T/2−t) is equal to the signal x(T/2+t) after applying time reversal around the reference time T/2.

The amplitude weighting p(t) of equation 2 may correspond, for example, to a weighting of Tuckey type over a time duration equal to the duration of the sub-interval in question Uₖ, with a rising and falling edge of duration of the order of 5%. Such a weighting makes it possible to avoid the occurrence of a broadband transient on each transition between sub-intervals, which would have a negative impact on the discretion of the transmission.

In the embodiments in which the weighting function p(t) is a Tukey weighting, the weighting may be defined over the interval [0,T] by the following equations:

p(t)=sin²(π.t/(2rT)) if 0≦t<rT

p(t)=1 if rT≦t<(1−r)T

p(t)=sin²(π.(T−t)/(2rT)) if (1−r).T≦t<T

In the above equations, the parameter r denotes a parameter (in particular taken between 0 and 0.5) that allows the width of the rising and falling edges of the weighting function to be adjusted. For example, the parameter r may be taken to be equal to 0.05.

The phase terms “exp j.βₖ” of equation 2, where k is in the interval [−M, M] and βₖ is in the interval [0, 2π], are used to scramble the auxiliary signal Ψ(x)(t), making its detection and reconstruction impossible by a third party without knowledge thereof. They thus form the steganographic key of the communication system (in this instance, for example, a key of length 2M) required to retrieve the hidden information.

In one embodiment, the phase parameter exp j.βₖ may be limited to two values: −1 and/or +1.

It should be noted that for exp jβₖ=1 (k belonging to [−M, M]), the auxiliary signal Ψ(x) (t) over the interval [nT, n+1T] corresponds to a time-reversed copy of the initial signal over this same interval.

In addition to its satisfactory properties in terms of discretion, this transformation operator W leads to a system that is relatively robust to Doppler shift for chosen guard intervals and lengths of sub-intervals Uₖ. For example, for a constant Doppler shift (stated otherwise, a time dilation factor q=1+V/c, where V denotes the radial velocity of the transmitter/receiver, and c denotes the speed of sound), the signals are deformed in an identical manner over the sub-intervals Uₖ and U₋ₖ ((the system is therefore robust to Doppler shift). The guard intervals, corresponding to the spaces between the sub-intervals Uₖ and Uₖ₊₁, may be chosen such that each of the sub-intervals Uₖ, after dilation and/or compression due to Doppler shift, does not overlap with its neighbors. The system may then be made robust to Doppler shift by compensating, on reception, for the difference between the value of the nominal carrier frequency, Fc, and that of the carrier affected by Doppler shift, “q. Fc”.

Various types of transformation operators Ψ resulting from any permutations between the signals over the sub-intervals Uₖ, with or without time reversal over each sub-interval, may also be chosen. With such transformation operators Ψ, it may be useful to compensate for the carrier frequency residual and the compression/dilation resulting from Doppler shift.

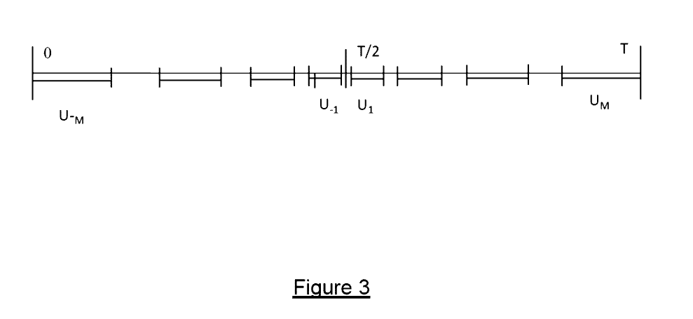

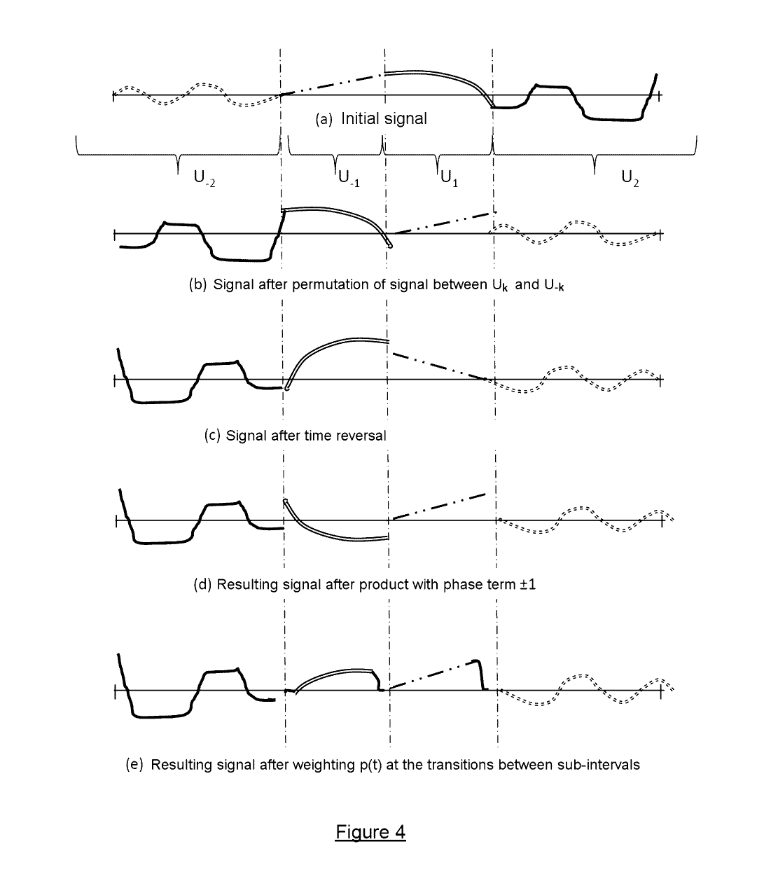

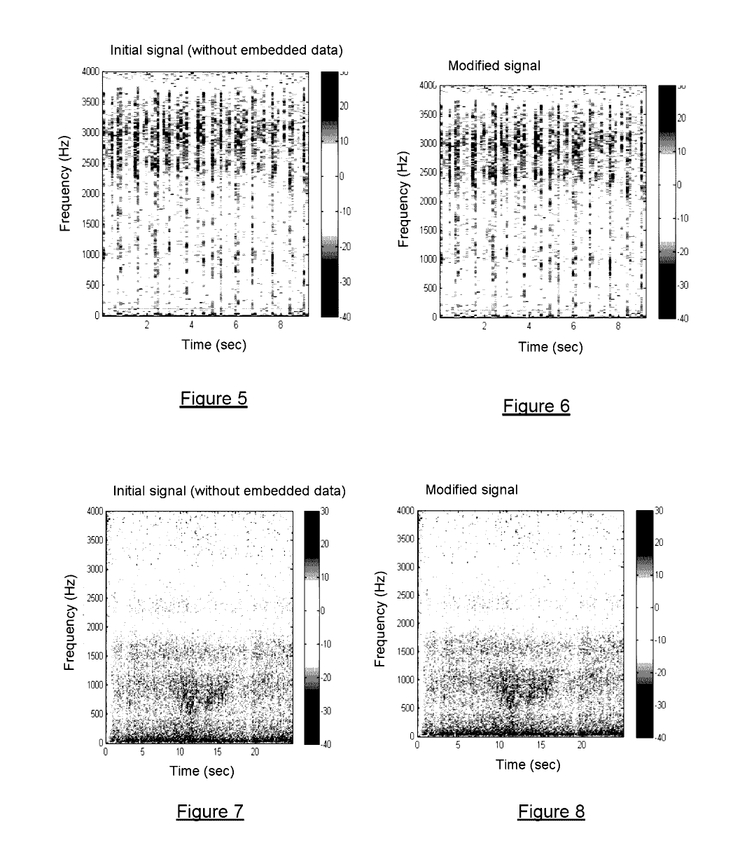

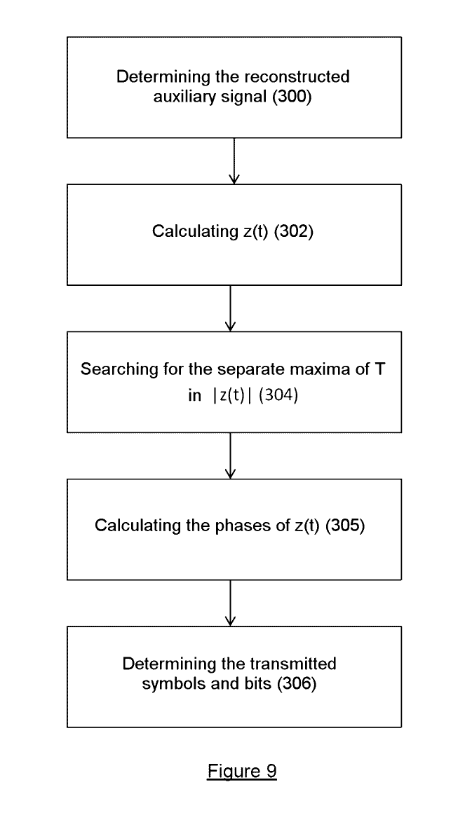

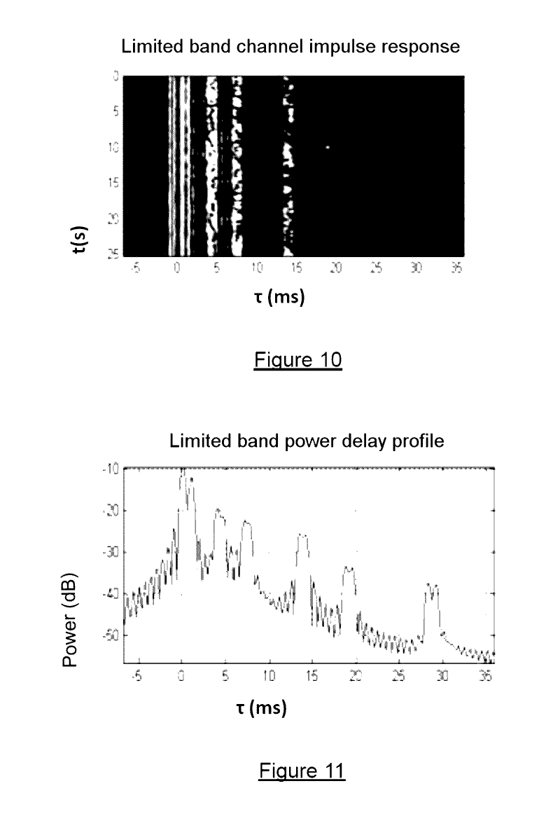

FIG. 4 illustrates one exemplary embodiment of steps 200 and 202, according to the first embodiment of the invention. This figure shows:

(a) the initial signal x(t) over an interval of duration T, in this instance divided into four sub-intervals U₋₂, U₋₁U₁, U₂;

(b) the signal after permutation of the signals over U₋₂ and U₂, then U₋₁ and U₁;

(c) the signal after time reversal of the signal over the set of sub-intervals Uₖ;

(d) the resulting signal after multiplication by the phase terms that form the steganographic key, in this instance (1, −1, −1, 1);

(e) the signal after application of a weighting p(t) in the guard intervals at the transitions between sub-intervals.

FIGS. 5 and 6 show exemplary results obtained by applying the transmission method of FIG. 2, according to the first embodiment, for signals collected at sea corresponding to a sequence of 10 seconds of sperm whale clicks. FIGS. 7 and 8 show other exemplary results obtained by applying the transmission method of FIG. 2, according to the first embodiment, for signals collected at sea corresponding to a sequence of 25 seconds of rain noise.

More particularly, FIGS. 5 and 7 represent the original signal x(t) in both cases (sperm whale clicks and rain noise) while FIGS. 6 and 8 respectively represent the corresponding modified signals obtained by addition of the auxiliary signal to with addition of the hidden information (by multiplication of the auxiliary signal by the symbol aₙ). In the two examples considered, the information has been added within the 1500-3000 Hz band, with a bit rate equal to 2 bit/sec, with a period T of 0.5 seconds, BPSK (binary phase-shift keying) modulation, without error-correcting code and with a gain α taken to be equal to −10 dB.

It may be observed that the sonograms of the initial and modified signals are almost indiscernible, thereby showing the discreet character of the modulation.

FIG. 9 is a flowchart describing the method for receiving the transmitted signal, according to certain embodiments of the invention.

The signal received by the receiver may advantageously be used if the auxiliary signal is added at a low level with respect to the initial signal. This low level makes it possible to calculate an effective approximation of the auxiliary signal, to detect it and to retrieve the hidden information via suitable filtering.

In step 300, an approximation of the received auxiliary signal Ψ(x) (t) (also referred to as the “reconstructed auxiliary signal” hereinafter) is determined by calculating Ψ(y) (t).

In step 302, a quantity z(t) is calculated by applying a suitable filter to the reconstructed auxiliary signal Ψ(x)(t), the auxiliary signal being temporally sampled at Fe >2B according to the Nyquist criterion. The quantity z(t) is given by equation 3 below:

z(t) [symbol] ∫₀^{T}[Ψ(y)(u)]*.(u)y(u). [symbol] du (equation 3)

In equation 3, the term [symbol] is introduced in order to compensate for le carrier residual Fc.V/c (corresponding to the difference between the carrier frequency with Doppler shift Fc (1+V/c) and the nominal carrier frequency Fc). This term [symbol] is estimated by maximizing, at each instant in time, the modulus of the quantity z(t) for a set of 2.R+1 of possible values of θ, denoted by θᵣ, according to the following equation 4:

θᵣ=2π.r.Fc.ΔV/c for −R ≦r≦R;

In equation 4:

ΔV denotes the difference between possible velocities of the grid in terms of velocity;

c denotes the speed of sound.

In step 304, separate maxima of T are sought in the modulus of the signal z(t) (the modulus of z(t) is denoted by |z(t)|), with a tolerance that may depend on the maximum Doppler shift.

In step 305, the phases of the signal z(t) are calculated at the instants in time corresponding to these maxima.

In step 306, the transmitted bits and symbols are determined from the phases calculated in step 305, thereby providing the hidden information.

The reception method may additionally comprise a synchronization step based on searching for and extracting correlation peaks at a frequency close to the frequency expected for the peaks, equal to 1/T (for example with a tolerance dependent on the maximum expected Doppler shift).

FIGS. 10 and 11 illustrate steps 302 to 306 for one exemplary embodiment in which an original signal has been simulated in a doubly (time- and frequency-) spread acoustic channel. The acoustic channel has been simulated with the following simulation parameters:

carrier frequency: 2250 Hz—band: [1500-3000] Hz

transmitter/receiver distance: 5000 m

depth of water: 100 m (flat bottom)

immersion depth of transmitter and receivers equal to 5 and 60 meters

Doppler spread: 0.5 Hz

Such a simulated acoustic channel corresponds to a submarine acoustic channel that is typical for a coastal environment, moderately difficult for acoustic communications.

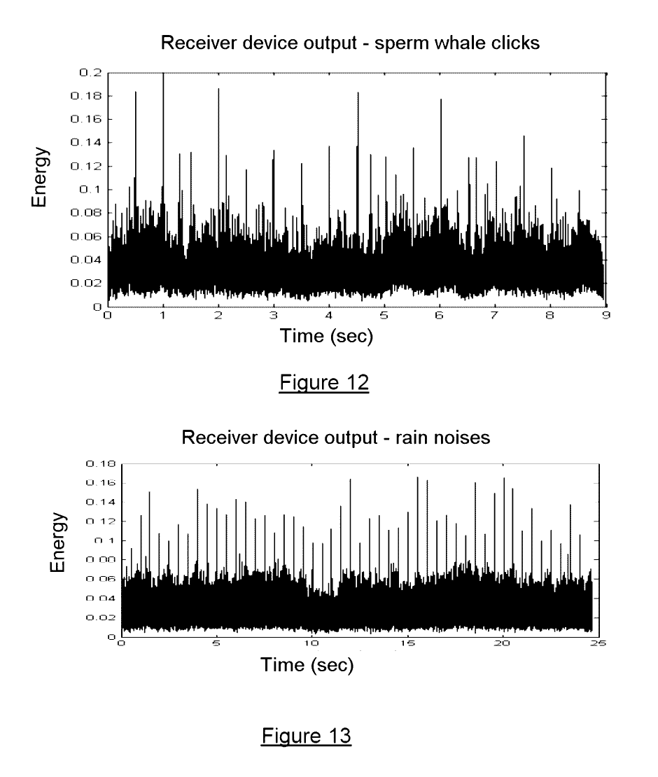

The result of step 302 is represented in FIGS. 12 and 13, in terms of modulus, for the two exemplary initial signals considered in FIGS. 5 to 8 (sperm whale clicks and rain noise), after propagation through the acoustic channel and addition of additive white Gaussian noise, with a signal-to-noise ratio that is equal to 0 dB in the 1500-3000 Hz frequency band in which the information is transmitted. The signal-to-noise ratio is equal to the ratio of the energies of the overall acoustic signal and of the noise. The useful signal-to-noise ratio, i.e. the energy of the added auxiliary signal, with gain α <1, carrying the information, may be lower. In the examples of FIGS. 12 and 13, a non-zero Doppler shift, for a radial velocity that is equal to 1.7 m/s, has been simulated by resampling the transmitted signal before passing through the channel and adding the Gaussian noise.

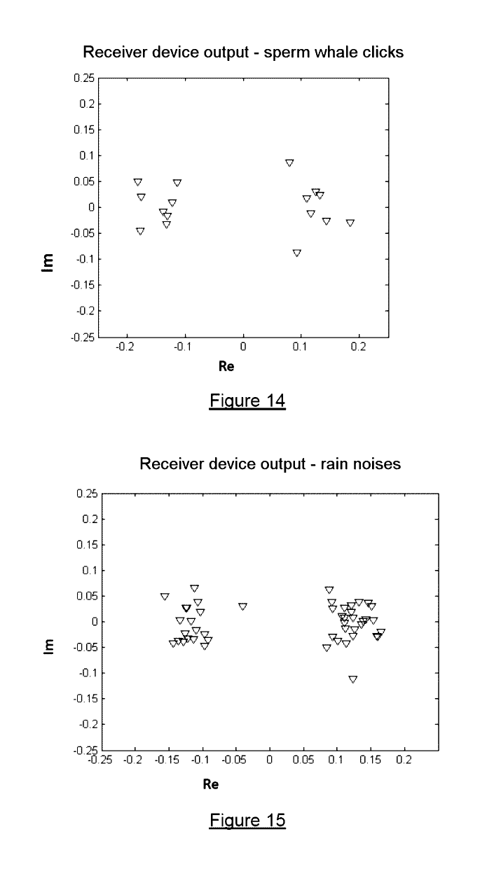

FIGS. 14 and 15 illustrate the estimated symbols obtained in step 306, after synchronization and compensation for the phase shift due to the channel, according the embodiment using a known symbol transmitted at the start of transmission.

It may be observed that if the symbols are correctly estimated, the transmitted message (of 16 bits for FIG. 14 or 50 bits for FIG. 15) is recovered without error.

In a second embodiment of the division and association steps 200 and 204, the interval T is divided into M sub-intervals of the same duration T/M (step 200). From the signal over each interval T, the auxiliary signal Ψ(x) (t) may subsequently be determined (step 202) from the signal initial x(t) by means of one or more permutations of any type between the chunks of the initial signal on the sub-intervals (i.e. the value of the auxiliary signal on a given sub-interval of time is obtained from the value of the initial signal on another sub-interval), whether they are time-reversed or not for each sub-interval (i.e. the value of the auxiliary signal at a time t belonging to a given sub-interval of time may be obtained from the value of the initial signal at time −t on another sub-interval). The applied permutations and time reversals then form the steganographic key of the system, which may be richer or longer than for 44 the first embodiment of the association step 202.

Step 204 may subsequently be implemented as described above with reference to FIG. 2 (adding the auxiliary signal multiplied by the symbol whose amplitude and/or phase carries the information and, if applicable, by a gain α). Furthermore, the reception method, such as described with reference to FIG. 9, may be applied similarly in this second embodiment.

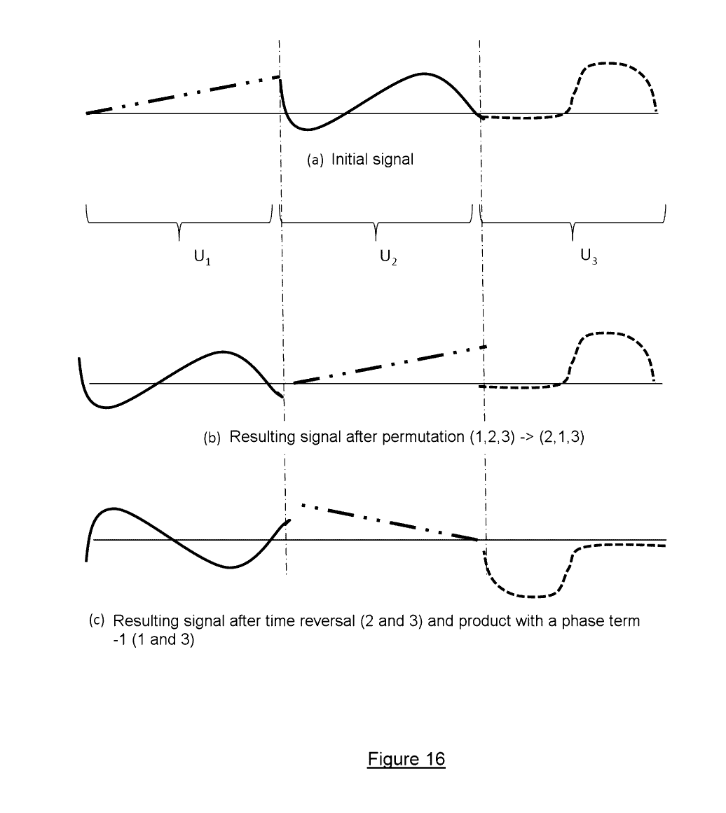

FIG. 16 illustrates one exemplary embodiment of steps 200 and 202, according to the second embodiment. This figure shows:

(a) the initial signal x(t) over an interval of duration T, divided into three sub-intervals U₁, U₂, U₃;

(b) the signal after permutation of the signals over the sub-intervals: the signal over U₁ is permuted with the section of signal over U₂, the signal over U₂ is permuted with the section of signal over U₁ and the signal over U₃ is permuted with the section of signal over U₃ (the permutation may then be denoted by (1,2,3)→(2,1,3));

(c) the signal after time reversal over the sub-intervals 2 and 3, then as a product of the phase terms (−1, 1, −1).

The successive operations b and c allow the auxiliary signal Ψ(x)(t) to be obtained.

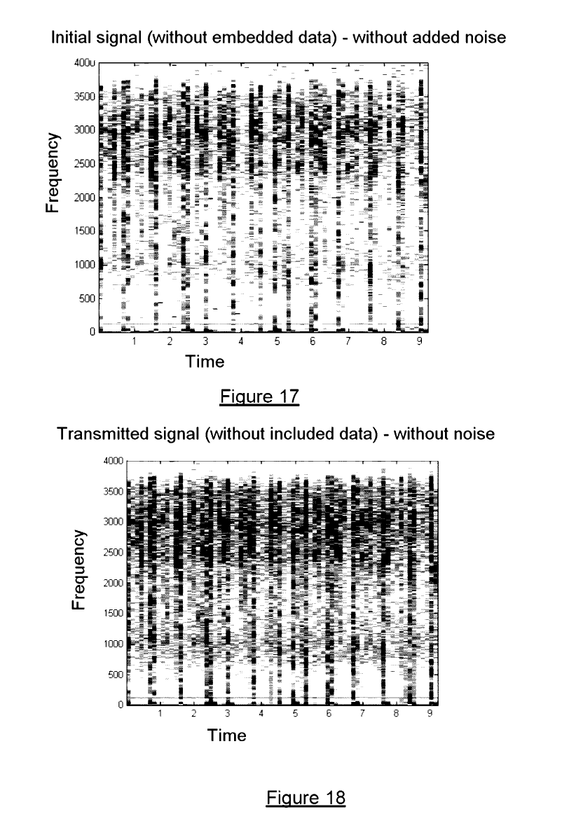

One exemplary application of the second embodiment is represented in FIGS. 17 and 18. In this example, the transmitter and the receiver are fixed, the channel is ideal and the initial signal (represented in FIG. 17) corresponds to the eight-second recording of sperm whale clicks. Each interval of one second has been divided into 32 sub-intervals between which the signal has been permuted as explained above.

The obtained results appearing in FIGS. 17 and 18 are comparable, in terms of attainable bit rate, to those obtained with the first embodiment of steps 200 and 202 (FIGS. 5 and 6). These results may appear less satisfactory in terms of discretion, due to the fact that less use of the signal has been made in the entire 0-4 kHz band and that it is without amplitude weighting, the jumps between sub-intervals creating broadband noise which is apparent when observing FIGS. 17 and 18 in detail. An amplitude weighting allows the situation to be improved.

It should be noted that the resemblance of the modified signal (FIG. 18) to the initial signal (FIG. 17) is excellent, such that it is difficult to detect that the initial signal has been modified.

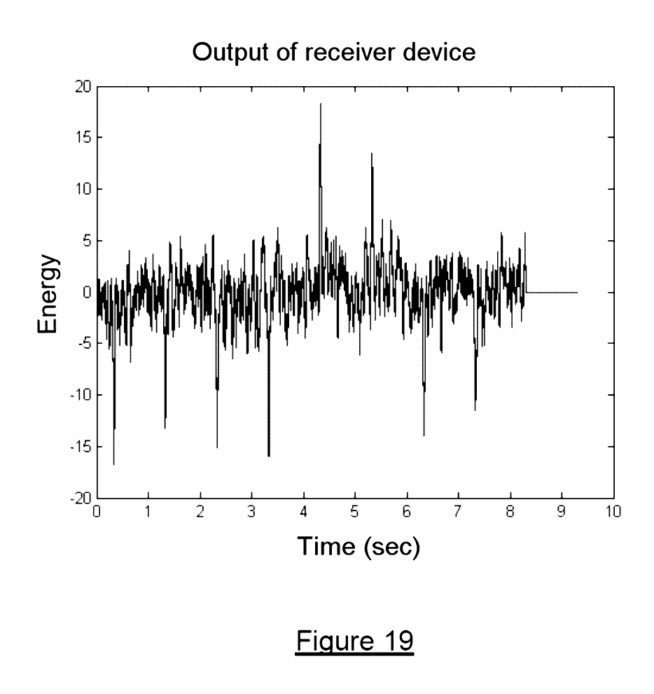

FIG. 19 illustrates the obtained output of the receiver device for the modified signal of FIG. 18. FIG. 19 shows a set of peaks spaced one second apart and whose amplitudes are close to +1 or −1, to within a multiplicative constant, perfectly corresponding to the transmitted sequence of eight bits (error-free transmission).

The second embodiment of steps 200 and 202 has the advantage of providing a very rich steganographic key. It may be useful to make it more robust to Doppler shift, by compensating for the carrier residual as in the first embodiment of these steps 200 and 202, and/or by compensating for the dilation/compression of the complex baseband signal around the carrier (envelope) with a level of precision of the order of the time sample.

In the embodiments in which the receiving antenna comprises multiple hydrophones 12, the reception method described with reference to FIG. 8 may be applied in parallel to the signals corresponding to the set of beams formed (for example, the beams may be formed across the entire horizon in the absence of a priori information on the position of the transmitter).

The invention thus enables retransmission of a signal previously recorded and modified so as to carry information from the addition of information by means of an auxiliary signal calculated from the initial signal and from the hidden information according to the transformation operator that depends on a steganographic key, knowledge of this key being required to detect that information is hidden and to retrieve this information.

The communication system 100 may use natural signals (such as biological noises, submarine construction, ambient noise, etc.) and imperceptibly modify them to include information therein (for example short messages of SMS type). The hidden information may be accessed only by using the steganographic key known only to the transmitter and to the receiver.

Consequently, the transmitted signal appears perfectly natural to all third parties and may be perfectly adapted to the time and place of transmission (for example, if the initial signal has been picked up in the area a few minutes or a few hours before its retransmission).

The use of amplitude weighting p(t) on transmission and/or on reception makes it possible to limit the broadband transients at the transitions between sub-intervals and to make the insertion of information more discreet.

The communication system 100 may be applied to any type of broadband signal, which is the case with numerous constituent signals of submarine ambient noise.

Although it is not limited to such an environment, the communication system 100 is particularly suitable for a very noisy environment and may be made insensitive to Doppler shift.

The invention is not limited to the embodiments described hereinabove by way of non-limiting example. It encompasses all the variant embodiments that may be envisaged by the person skilled in the art.

1. A transmitter device, comprising a transmission antenna, the transmission antenna comprising at least one transducer and one signal generation unit for generating an acoustic communication signal to be transmitted to a receiver device including hidden information, wherein the signal generation unit is configured to previously record an original acoustic signal, said signal generation unit being capable of generating said communication signal to be transmitted by adding, to an initial signal x(t) derived from the original signal, an auxiliary signal previously multiplied by at least one symbol, said symbol having a phase and/or an amplitude carrying the hidden information and said auxiliary signal being calculated from the initial signal by means of a chosen transformation operator which depends on a steganographic key.

2. The transmitter device as claimed in claim 1, wherein the initial signal derived from the original signal is the complex baseband signal obtained after filtering the original signal in a frequency band of chosen width, centered on a central frequency.

3. The transmitter device as claimed in claim 1, wherein the signal generation unit is configured to previously divide the total duration of the original signal x(t) into a set of contiguous successive time intervals of the same duration T, the transformation operator being applied to the initial signal on each of said intervals in order to calculate the value of the corresponding auxiliary signal on said interval.

4. The transmitter device as claimed in claim 3, wherein the signal generated y(t) at a time t belonging to the n^{th} interval [nT, (n+1)T] is equal to:
y(t)=x(t)+α. aₙ. Ψ(x)(t),
where a denotes a gain parameter and aₙ denotes the symbol corresponding to the n^{th} interval.

5. The transmitter device as claimed in claim 3, wherein the signal generation unit is additionally configured to divide the duration of the signal into a set of contiguous successive time intervals of the same duration T, and each interval of duration T into 2M sub-intervals U_{-M}, . . . , U_{31 1}, U₁, . . . , U_{M}, separated by guard intervals, the durations of said sub-intervals increasing as a function of the absolute value of k, and wherein the transformation operator is applied to the initial signal over each sub-interval Uₖ in order to calculate the corresponding value of the auxiliary signal over said interval.

6. The transmitter device as claimed in claim 5, wherein the value of the auxiliary signal Ψ(x)(T/2+t) at a time T/2+t, where t belongs to a sub-interval Uₖ, is a function of a phase parameter exp j.βₖ, with βₖ being comprised in the interval [0, 2π] and k being comprised in the interval [−M, M], of the value of an amplitude weighting function p(t) at time t, and of the value of the initial signal at time (T/2−t).

7. The transmitter device as claimed in claim 6, wherein the value of the auxiliary signal Ψ(x)(T/2+t) at a time T/2+t, where t belongs to a sub-interval Uₖ, is equal to:
Ψ(x) T/2+t)=exp j.βₖ .p(t). x(T/2−t).

8. The transmitter device as claimed in claim 5, wherein the duration of the guard intervals between the sub-intervals of successive times Uₖ and Uₖ₊₁ is chosen such that each of the sub-intervals Uₖ does not overlap with its neighbors after dilation/compression due to a Doppler phenomenon.

9. The transmitter device as claimed in claim 3, wherein the signal generation unit is further configured to divide each interval of duration T into a set of M sub-intervals of the same duration T/M, and wherein the value of the auxiliary signal in a given sub-interval of time is obtained from the value of the initial signal in another sub-interval.

10. The transmitter device as claimed in claim 9, wherein the value of the auxiliary signal at a time t belonging to a given sub-interval of time is obtained from the value of the initial signal at time −t in another sub-interval.

11. The transmitter device as claimed in claim 9, wherein the value of the auxiliary signal at a time t belonging to a given sub-interval of time is obtained from the value of the initial signal in another sub-interval weighted by the value of an amplitude weighting function p(t) at time t.

12. A receiver device, comprising a receiving antenna, the receiving antenna comprising at least one hydrophone, comprising a detector for detecting a communication signal transmitted by a transmitter device as claimed in claim 1 and an extraction unit configured to reconstruct the auxiliary signal by applying said transformation operator to the detected communication signal from the steganographic key, and to extract the hidden information from the phase and/or the amplitude of the reconstructed auxiliary signal.

13. The receiver device as claimed in claim 12, wherein the extraction unit is further configured to apply a filter to the reconstructed signal on the basis of a compensation term [symbol] capable of compensating for the residual of the carrier corresponding to the difference between the carrier frequency with Doppler and the nominal carrier frequency, the compensation term being estimated by maximizing, at each time t, the modulus of the output z(t) of the filter for a set of possible values of θ, and wherein the extraction function is capable of determining the symbols and the bits of the hidden information from the phases of the signal z(t) that are calculated at times corresponding to the maxima of the modulus of the signal z(t).

14. A communication system comprising a transmitter device as claimed in claim 1 and a receiver device comprising a receiving antenna, the receiving antenna comprising at least one hydrophone, comprising a detector for detecting a communication signal transmitted by a transmitter device and an extraction unit configured to reconstruct the auxiliary signal by applying said transformation operator to the detected communication signal from the steganographic key, and to extract the hidden information from the phase and/or the amplitude of the reconstructed auxiliary signal.

15. A transmission method for generating an acoustic communication signal in a transmitter device, comprising a transmitting antenna, the transmitting antenna comprising at least one transducer, the method comprising the following steps:
a. recording an original acoustic signal;
b. adding, to an initial signal x(t) derived from said original signal, an auxiliary signal multiplied by at least one symbol, said symbol having a phase and/or an amplitude carrying the hidden information and said auxiliary signal being calculated from the initial signal by means of a chosen transformation operator which depends on a steganographic key, thereby providing a communication signal;
c. transmitting a signal to a receiver device on the basis of the communication signal obtained in step b.
